(19) United States
(12) Patent Application Publication
(10) Pub. No.: US 2021/0233120 A1
(43) Pub. Date: Jul. 29, 2021

(54) AUTHORIZATION AND TERMINATION OF THE BINDING OF SOCIAL ACCOUNT INTERACTIONS TO A MASTER AGNOSTIC IDENTITY

(71) Applicant: T-Mobile USA, Inc., Bellevue, WA (US)

(72) Inventors: Vinay Kshirsagar, Sammamish, WA (US); James Ellison, Issaquah, WA (US); Robert Stamm, Sammamish, WA (US)

(21) Appl. No.: 17/231,888

(22) Filed: Apr. 15, 2021

Related U.S. Application Data
(62) Division of application No. 15/154,877, filed on May 13, 2016, now abandoned.
(60) Provisional application No. 62/162,627, filed on May 15, 2015.
(60) Provisional application No. 62/162,630, filed on May 15, 2015.
(60) Provisional application No. 62/162,632, filed on May 15, 2015.

(51) Int. Cl. G06Q 30/02; H04L 29/06; G06F 16/9535; H04W 12/06; G06Q 30/06; G06F 21/31

(52) U.S. Cl. CPC G06Q 30/0269; H04L 63/102; G06Q 30/0277; G06F 16/9535; H04L 63/0815; G06Q 50/01; H04W 12/06; G06Q 30/06; G06F 21/31; G06Q 30/0276; H04L 63/0884

(57) ABSTRACT

This disclosure sets forth systems and techniques that integrates social networking services with vendor services, such that a user may directly or indirectly communicate their experience, impression, or intention to a vendor via a user's preferred social networking service. In some examples, the social networking services may facilitate a vendor providing technical service support for a product or service. In other examples, a user may initiate a transaction with the vendor via a preferred social networking service. The user may initiate payment for an outstanding bill, initiate a purchase of vendor products or services, solicit a trade-in estimate for a particular product, query an order status, or initiate a data-allowance transfer to a recipient of a telecommunications vendor. In each of these examples, the user may communicate with a vendor by via social media posts on a social networking services authorized via a vendor platform.

### RELATED APPLICATIONS

This application claims priority to a co-pending, commonly owned U.S. Provisional Patent Application No. 62/162,627 filed on May 15, 2015, and titled “Binding Social Account Interactions to a Master Agnostic Identity,” U.S. Provisional Patent Application No. 62/162,630 filed on May 15, 2015, and titled “Authorization and Termination of the Binding of Social Account Interactions to a Master Agnostic Identity,” and U.S. Provisional patent Application No. 62/162,632 filed on May 15, 2015, and titled “Social Media Assisted Network Coverage Diagnosis,” which are herein incorporated by reference in their entirety.

### BACKGROUND

Present day, users of telecommunication and internet technologies tend to engage with other users via social networking services. Social networking services may provide a forum for users to publish information that may relate to personal experiences or impressions of products, services, events, or activities that may interest the user. Thus, social networking services that cater for a large number of users can maintain a large amount of social data that may be relevant to vendors looking to market their offerings of various products, services, events, or activities. Vendors may include merchants of an electronic marketplace that offer products, events, services, and activities to online users, a subset of which include social media users. Vendors may find such information useful in identifying issues and concerns that relate to their products, services, events, or activities.

While social networking services may be a useful medium for a vendor to advertise offerings of various products, services, events, and activities, there remains a need to integrate social networking services with vendor marketing and support services, such that a user may directly or indirectly communicate their experience, impression, or intention to a vendor via the user's preferred social networking service.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a schematic view of a vendor-social media integration system that interacts with authorized social media platform and a vendor.

FIG. 2 illustrates a block diagram of a vendor-social media integration system that provides a capability for a vendor to communicate with a user via an authorized social networking service.

FIG. 3 illustrates a block diagram of a vendor-social media integration system facilitating a payment transfer from a user to a vendor.

FIG. 4 illustrates a block diagram of a vendor-social media integration system facilitating a data-allowance transfer from a user to a recipient of a telecommunications service vendor.

FIG. 5 illustrates a block diagram of a vendor-social media integration system facilitating a technical support request from a use to a telecommunications service vendor.

FIG. 6A illustrates an exemplary user interface of a user device that may customize an authorization of a social media network service. FIG. 6B illustrates an exemplary user interface of a user device that displays a listing of prior communications with a vendor platform.

FIG. 7 illustrates an exemplary user interface of a vendor platform that may facilitate interactions with an authenticated user.

FIG. 8 illustrates a flow diagram that describes a process of authorizing an association between a social media platform account and a vendor account, and retrieving data from the social media platform account based at least in part on the authorized association.

FIG. 9 illustrates a flow diagram that describes a process of identifying a misuse event of social media posts that may cause a termination of the association between a social media platform account and a vendor account.

FIG. 10 illustrates a flow diagram of a process of initiating one or more vendor actions in response to receiving a user request via an authorized social media platform.

FIG. 11 illustrates a flow diagram of a process for determining a type of vendor actions to perform based on a database query of similar requests for vendor support from other authenticated users.

### DETAILED DESCRIPTION

This disclosure sets forth systems and techniques that integrates social networking services with vendor services, such that a user may directly or indirectly communicate their experience, impression, or intention to a vendor via a user's preferred social networking service. In some examples, the social networking services may facilitate a vendor providing technical service support for a product or service. In other examples, a user may initiate a transaction with the vendor via a preferred social networking service. The user may initiate payment for an outstanding bill, initiate a purchase of vendor products or services, solicit a trade-in estimate for a particular product, query an order status, or initiate a data-allowance transfer to a recipient of a telecommunications vendor. In each of these examples, the user may communicate with a vendor by via social media posts on a social networking services authorized via a vendor platform.

In various examples, the vendor may monitor social media communications on an authorized social networking service to identify social media posts that may be directly or indirectly related to the vendor. For example, the vendor may identify relevant social media posts based on detecting a direct reference to the vendor in the social media post. In this example, the user may have intended for the social media post to have been directed to the vendor. In other examples, the vendor may identify social media posts that includes an indirect reference to a vendor. For example, a user may post a social media post that expresses a dissatisfaction with a product or service of the vendor, without explicitly identifying the vendor. In this example, the vendor may detect the social media post and posit that the social media post is likely related to a dissatisfaction with a vendor product or service. In both examples, the vendor may provide a response to a direct or indirect social media post via the same authorized social media platform.

A vendor, as described herein, may refer to any merchant that offers products, events, services, or activities. In some examples, a vendor may correspond to a merchant of an electronic marketplace that offers products, events, services, or activities to online users, a subset of which includes social media users. In other examples, a vendor may correspond to a telecommunications service provider, offering telecommunications services to a network of users. It is noteworthy that throughout the disclosure, the term “vendor products and services” is intended to describe all vendor offerings, such as products, events, services, and activities.

A social media platform, as described herein, may refer to a computer-mediated tool that allows users to create, share, or exchange information, interests, ideas, pictures, and videos in virtual communicates and networks. In some examples, social media platforms may be an internet-based application that support user-generated content, where users may create service-specific profiles that are maintained by the social media platform. A social media platform may further facilitate the development of online social networks by connecting user profiles with those of other individuals and/or groups that share common attributes.

The term “social networking services,” as described herein may refer to services that facilitate interaction among users, via a computing platform. An interaction may be based on shared interests, activities, backgrounds, real-life connections, or on-line connections. Alternatively, or additionally, social networking services may be based on providing a medium for a user to share her ideas, pictures, posts, activities, events, and interests with other users, irrespective of whether a real-life connection or an online connection with the other users exists. Social networking services may also include additional services that relate to engaging users through their interests, such as advertisements of vendor products and services, and access to media services that may interest the user, such as entertainment, news, public relations, and so on.

The term “techniques,” as used herein, may refer to system(s), method(s), computer-readable instructions, module(s), algorithms, hardware logic, and/or operation(s) as permitted by the context described above and throughout the document.

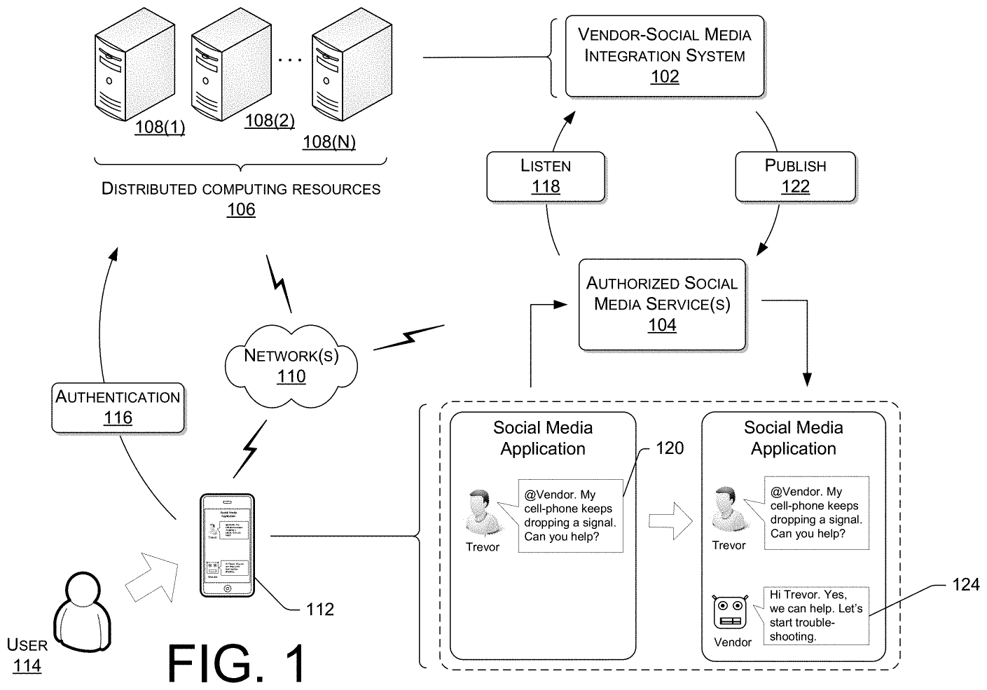

FIG. 1 illustrates a schematic view of a vendor-social media integration system 102 that interacts with authorized social media platform(s) 104 and a vendor. In various examples, the vendor-social media integration system 102 may monitor social activity of the user on authorized social media platform(s) 104 that is directly or indirectly related to the vendor. In some examples, the vendor-social media integration system 102 may identify relevant social media posts based on detecting a direct reference to the vendor in the social media post. In this example, the user may have intended for the social media post to have been directed to the vendor. In other examples, the vendor-social media integration system 102 may identify social media posts that includes an indirect reference to a vendor. For example, a user may post a social media post that expresses a dissatisfaction with a product or service of the vendor, without explicitly identifying the vendor. The vendor-social media integration system 102 may detect the social media post and posit that the social media post is likely related to a dissatisfaction with the vendor. In both examples, the vendor-social media integration system 102 may provide a response to a direct or indirect social media post that is associated with the vendor.

In the illustrated example, the vendor-social media integration system 102 may operate on one or more distributed computing resource(s) 106. The one or more distributed computing resource(s) 106 may include one or more computing device(s) 108 that operate in a cluster or other configuration to share resources, balance load, increase performance, provide fail-over support or redundancy, or for other purposes.

The one or more computing device(s) 108 may include one or more interfaces that enable communications with electronic device(s), via one or more network(s) 110. The electronic device(s) may include any sort of electronic device, such as a cellular phone, a smart phone, a tablet computer, an electronic reader, a media player, a gaming device, a personal computer (PC), a laptop computer, etc. The electronic device may also be a mobile telecommunication device, such as user device 112 that is associate with user 114. In this example, the user device 112 is capable of being moved from location to location and used in a plurality of locations. The user device 112 may have a subscriber identity module (SIM), such as an eSIM, to identify the user device 112 to a telecommunication service provider network (also referred to herein as “telecommunication network”).

Further, the one or more network(s) 110 may include public networks such as the Internet, private networks such as an institutional and/or personal intranet, or some combination of private and public networks. The one or more network(s) 110 can also include any type of wired and/or wireless network, including but not limited to local area network (LANs), wide area networks (WANs), satellite networks, cable networks, Wi-Fi networks, WiMax networks, mobile communications networks (e.g., 3G, 4G, and so forth) or any combination thereof.

In the illustrated example, the vendor-social media integration system 102 may authenticate 116 a user identity to the vendor platform. An authentication 116 of user device 112 access to a user account on the vendor platform may require entry of a username and password, a biometric identifier, or a device identifier. The device identifier may correspond to an MSISDN number of the user device 112 that is associated with the vendor-social media integration system 102. The MSISDN number may be used to automatically authenticate the user device 112 to the vendor-social media integration system 102, in response to the user device 112 operating on a vendor-supported telecommunication network. The term “MSISDN,” as used herein, may describe a “Mobile Station International Subscriber Directory Number,” which further describes a primary key to a record that contains details of a user that is authorized on a telecommunication network.

Alternatively, the device identifier may correspond to an aggregated user identifier managed by a communications carrier, such as T-Mobile ID (TM). Specifically, a communications carrier manages identifier requests by mapping one or more devices, cellular or WIFI or otherwise to a user identifier specific to the carrier, in a supplementary table communicative with a Home Location Register or a Home Subscriber Service, or other carrier user database.

In various examples, once a user device 112 associated with a user 114 has been authenticated 116 to the vendor, the vendor-social media integration system 102 may listen to social media posts published by the authenticated user on authorized social media platform(s) 104. A user may optionally provide the vendor-social media integration system 102 with access to the authorized social media platform(s) 104 via the vendor account. An association between the vendor account and a particular social media platform may be created via a click-through agreement that expressly grants the vendor-social media integration system 102 with permission to access the particular social media platform. Further, an association may be created by an entry in database. For example, if the association is in a flat file database, the database entry may have the vendor account and the social media account as fields in the same record. If the association is in a relational database, the accounts may be related in a cross reference table.

In the illustrated example, the vendor-social media integration system 102 may listen 118 to social media activity 120 of the user on the authorized social media platform(s) 104. Particularly, the vendor-social media integration system 102 may monitor social media activity that is directly or indirectly related to the vendor. In some examples, the vendor-social media integration system 102 identify relevant social media posts by detecting a vendor handler with, such as “@Vendor,” within the social media post. In this example, the user may have intended for the social media post to be directed to the vendor. In other examples, the vendor-social media integration system 102 may detect user comments that may relate to a vendor, without expressly identifying the vendor. For example, a user may post a social media post that expresses concern over poor network coverage. The vendor-social media integration system 102 may detect the social media post, and posit that the social media post is likely related to a dissatisfaction with the vendor.

In the illustrated example, the vendor-social media integration system 102 may publish 122 a reply post 124 to the social media activity 120 associated with the user. The reply post 124 may constitute a reply to a direct or indirect social media post that concerns a vendor product or service. In the illustrated example, the reply post 124 is a direct response to a user request for help regarding a dropped signal. In various examples, the reply post 124 may also include a solution to the problem. The solution may recommend a change to a product setting, a download of a software update, or a deletion of a problematic software application. In other examples, the solution may recommend an intervention by a customer service representative or network engineering team. In such instances, trouble tickets, problem solving instructions, and other information may be automatically provided in the reply post 124, and simultaneously sent to a customer service representative and network engineering team for further evaluation.

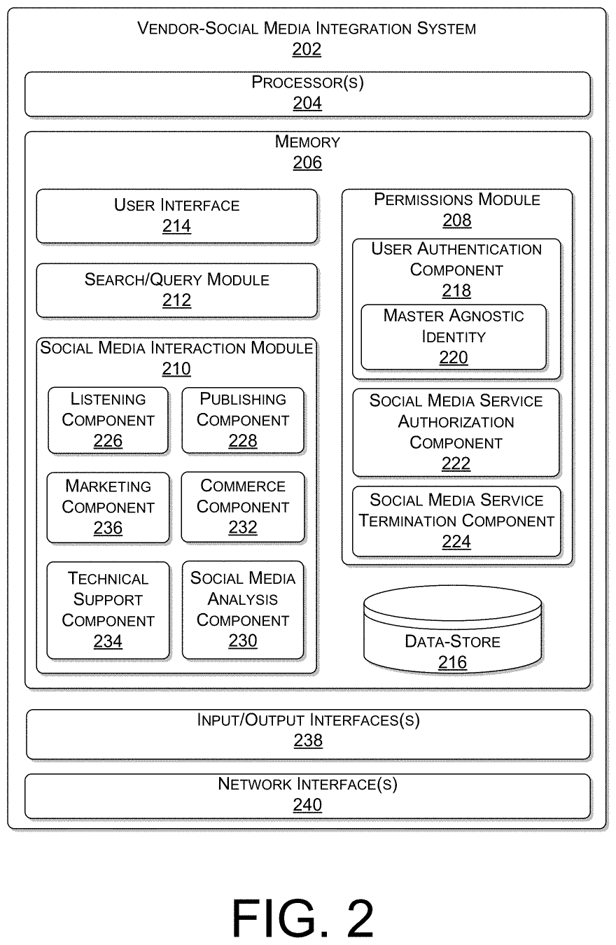

FIG. 2 illustrates a block diagram of a vendor-social media integration system 202 that provides a capability for a vendor and user to communicate with one another via a user-preferred and/or user-specified social networking service. In various examples, the vendor-social media integration system 202 may interact with a user-preferred and/or user-specified social networking service to send and receive social media posts that directly or indirectly related to a vendor account. In the illustrated examples, the vendor-social media integration system 202 may correspond to the vendor-social media integration system 202, and may include one or more processor(s) 204 that are operably connected to memory 206. In at least one example, the one or more processor(s) 204 may be a central processing unit(s) (CPU), graphics processing unit(s) (GPU), a both a CPU and GPU, or any other sort of processing unit(s). Each of the one or more processor(s) 204 may have numerous arithmetic logic units (ALUs) that perform arithmetic and logical operations as well as one or more control units (CUs) that extract instructions and stored content from processor cache memory, and then executes these instructions by calling on the ALUs, as necessary during program execution. The one or more processor(s) 204 may also be responsible for executing all computer applications stored in the memory, which can be associated with common types of volatile (RAM) and/or nonvolatile (ROM) memory.

In some examples, memory 206 may include system memory, which may be volatile (such as RAM), non-volatile (such as ROM, flash memory, etc.) or some combination of the two. The memory may also include additional data storage devices (removable ad/or non-removable) such as, for example, magnetic disks, optical disks, or tape.

The memory 206 may further include non-transitory computer-readable media, such as volatile and nonvolatile, removable and non-removable media implemented in any method or technology for storage of information, such as computer readable instructions, data structures, program modules, or other data. System memory, removable storage and non-removable storage are all examples of non-transitory computer-readable media. Examples of non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

In the illustrated example, the memory 206 may include a permissions module 208, a social media interaction module 210, and a search/query module 212, user interface 214, and a data-store 216. The permissions module 208 may further include a user authentication component 218 that authenticates a user device to the vendor platform. An authentication of the user device may require entry of a username and password, a biometric identifier, or a user device identifier. A biometric identifier may include, but is not limited to, a voice print of the user, a facial image of the user, or a finger-print of the user. Further, the user device identifier may include an MSISDN number, which may automatically authenticate the user device to the vendor platform when the user device is operating on a network supported by the vendor platform. The term “MSISDN,” as used herein, may describe a “Mobile Station International Subscriber Directory Number,” which further describes a primary key to a record that contains details of a user that is authorized on a network. In another example, the user device identifier may include an IMISI number, which similar to an MSISDN number, may automatically authenticate the user device to the vendor platform when the user device is operating on a network supported by the vendor platform. In the term “IMISI,” as used herein, may describe an “International Mobile Subscriber Identity,” and further describes a unique identification number that identifies a user of a cellular network and the cellular network itself.

Further, once the user authentication component 218 authenticates the user device to the vendor platform, a user may gain access to billing services, account information and profile information maintained by on the vendor platform. Further, the vendor platform may associate a master agnostic identity 220 with the user identity. A master agnostic identity 220 may be a non-descript term that associates the user identity with the vendor platform. In some examples, the master agnostic identity 220 may correspond to a vendor account number, a vendor username, or a vendor identification number that the vendor platform associates with the user. In other examples, the master agnostic identity 220 may be a non-descript term that is foreign to both the vendor platform and integrated social media platforms. A benefit of having a non-descript term as a master agnostic identity 220 is self-evident in that the master agnostic identity 220 cannot be used to identify a user without first having access to the data-store 216 on the vendor platform. Thus, a user's right of privacy is protected for transactional data and social profile data that is maintained on the vendor platform. Further, identifying a user by a master agnostic identity 220 may provide added identity protection for transactional data and social profile data transferred between the vendor platform and authorized social media platforms.

In various examples, the master agnostic identity 220 may be used to anonymously identify an authenticated user to one or more authorized social media platforms. For example, the master agnostic identity may be associated with unique social media platform IDs that correspond to the one or more authorized social media platforms. In doing so, a master agnostic identity may be used as a search term within the data-store 216 to identify the one or more authorized social media platforms.

The permissions module 208 may further include a social media authorization component 222 that authorizes an association between a vendor account and a social media platform. The social media authorization component 222 may optionally provide access to the social media platform via the vendor account. The association between the vendor account and a social media platform may be created in response to receiving express permission from the user. The user may provide such permission via a click-through agreement. The vendor may electronically present the click-through agreement on a user interface of a device associated with the user. The agreement may disclose the nature of the association between the vendor account and the social media platform. The user may use select all or a subset of selectable criteria upon which the agreement may be based. For example, the user may indicate that the agreement permits communications between the vendor and the social media platform that relate to managing the vendor account or enabling technical support services. Further, the user may also indicate, by selection, that the agreement does not permit the vendor to access social media posts for the purpose of marketing products or services.

The permissions module 208 may further include a social media termination component 224 that terminates an association between a vendor account and a social media platform. An association may be terminated in several ways. In one instance, an association may be configured to terminate at an expiration of a predetermined time period. For example, the vendor or the user, may elect to set an expiration of the association to occur at the end of a 30-day period. In another instance, an association may be terminated upon request from the user, the vendor, or due to modifications that occur to one of a social network account or the user account that is associated with the vendor. In one example, a user may update username and password information associated with a social media platform account. In doing so, the association between the social media platform account and the vendor may be terminated if the vendor-social media integration system 202 is unable to access the social media platform account using the credentials on file.

In some examples, the association between a vendor account and a social media platform may be terminated in response to detecting a misuse event. A misuse event may be detected by the vendor-social media integration system 202, or may be reported to the vendor by a social media platform. Alternatively, or additionally, a misuse event may be reported by the user. The misuse event may correspond a violation of a use-policy set by the vendor, a use-policy set by the authorized social media platform. In some examples, the use-policy set by the vendor may include the business rules identified in the click-through agreement that authorized the association between the vendor account and the social media platform account. In a non-limiting example, a use-policy set by the social media platform may indicate that social media data cannot be shared with third parties for the purpose of marketing third party products or services. Thus, a misuse event may be defined by an attempt to gain access to social media data for the purpose of marketing products or services to the user. Further, if the click-through agreement authorizes communications for the purpose of marketing products or services, a misuse event may occur if the terms of the click-through agreement contradict terms within the use-policy set by the vendor or the use-policy set by the social media platform. In other words, if the click-through agreement authorizes communications for marketing products or services, and the use-policy set by the social media platform does not authorize such communications, then a misuse event has occurred.

In other examples, the misuse event may be defined by a detection of fraudulent use of account details associated with the vendor account or the social media platform account. Fraudulent use of account details may include a compromised use of a master agnostic identity 220 associated with the user, social media platform account authentication details, vendor account authentication details, or any other user profile data that is securely stored by the vendor or the social media platform.

In the illustrated example, the memory 206 may further include a social media interaction module 210. The social media interaction module 210 may receive, process and respond to various social media posts that are made by the user that are directly or indirectly associated with the vendor. In some examples, the user may be directly requesting assistance from the vendor with an account. In other examples, the user may be expressing dissatisfaction with a product or service of the vendor, without expressly identifying the vendor. In both examples, the social media interaction module 210 may listen to such social media posts and provide an appropriate response that either provides the requisite assistance, or helps troubleshoot an expressed dissatisfaction.

In the illustrated example, the social media interaction module 210 may further include a listening component 226. The listening component 226 may monitor social media posts published by the user on an authorized social media platform that may be relevant to the vendor platform. In some examples, the listening component 226 may record a social media post ID that identifies a social media post published by the user on an authorized social media platform. In some examples, the social media post ID may be used to locate the actual social media post on the authorized social media platform. In some instances, the listening component 226 may flag social media posts that directly or indirectly mention the vendor, or a product or service that relates to the vendor. For example, a social media post may include a vendor handler, such as “@Vendor.” In this example, the listening component 226 may determine that an inclusion of the “@Vendor” handler suggests that the user most likely intends for the vendor to view the social media post. In another example, the listening component 226 may employ natural language processing to detect comments within a social media post that may relate to the vendor, without expressly identifying the vendor. For example, a user may publish a post on an authorized social media platform that states: “the network coverage here is poor. Is anyone else having problems getting a signal?” The listening component 226 may detect the social media post, and refer to a list of text patterns that indicate that the social media post is likely associated with a dissatisfaction of a vendor service, that being a telecommunications service offering. In various examples, the listening component 226 may detect social media posts that may help identify categories of products or services that may interest the user. The vendor may then use that data to generate advertisements for products and services offered by the vendor that align with the user's interests. For example, a user may publish a social media post that states “I need a new phone that has a better camera than my existing phone.” The listening component 226 may determine that the subject matter of the user's social media post aligns with a category of new phones offered by the vendor. In doing so, the vendor platform may publish an unsolicited social media post to an authorized social media platform associated with the user that advertises a new phone with improved camera capabilities.

In the illustrated example, the social media interaction module 210 may further include a publishing component 228. The publishing component 228 may enable responses and/or posts to be published on authorized social media platforms. In some examples, the responses may constitute a reply to a direct or indirect social media post about a vendor product or service. Referring to the previous example, the publishing component 228 may post a response to a user's comment about poor network coverage, with a reply stating “We're sorry that you're experiencing a poor quality of service. Rest assured, we are looking into it.” In some examples, the publishing component 228 may enable automated posts. An automated post may include a service announcement about a weather warning or an amber alert. An automated post may also include marketing advertisements that relate to vendor products or service. Further, automated posts may also relate to commerce processes that have been automated by the vendor. For example, the publishing component may post an automated post that confirms a payment or transaction via the vendor account. In other examples, the publishing component 228 may enable posts from service representatives troubleshooting a user problem, or processing a user request.

In the illustrated example, the social media interaction module 210 may further include a social media analysis component 230. The social media analysis component 230 include determine the logic to perform in response to detected social network activity. In one example, a user may publish a social media post that includes a request to pay an outstanding bill using a visa card. The social media analysis component 230 may employ natural language processing to determine that the user intends to pay an outstanding bill, and in doing so, send an indication to a commerce component 232 to process the request to pay the outstanding bill. In another example, a user may publish a social media post about poor network coverage. Thus, the social media analysis component 230 may send an indication to a technical support component 234 outlining the same.

The social media analysis component 230 may further generate a profile of each authenticated user based on social media posts published on authorized social media platforms. For example, a particular user may publish social media posts that suggest a preferred genre of music, or a preferred type of food. Thus, the social media analysis component 230 may interpret these posts and subsequently identify and include the authenticated user in categories that relate to the genre of music or the type of food. A marketing component 236 may then generate advertisements that are tailored to preferences of the authenticated user, based on the identified categories.

Further, the social media analysis component 230 may also provide an audit of various posts aggregated from different authenticated users on their respective authorized social media platforms. The audit may include an analysis of different workflow requests from authenticated users via authorized social media platforms. A workflow request may include a request to initiate payment for an outstanding bill, payment for the purchase of a product or a service, a request for technical support, an order status update, or a request to solicit a trade-in estimate for a particular product. In a non-limiting example, the audit may include a determination that a particular percentage of authenticated users prefer to use an authorized social media platform to perform some transactions that relate to a vendor account, however those same users may prefer an alternate communication medium when requesting technical support. A benefit of the audit data is that a vendor may use the audit information to implement additional workflow/rules in areas that are preferentially used by authenticated users.

In the illustrated example, the social media interaction module 210 may further include a marketing component 236. The marketing component 236 may generate one or more advertisements for distribution via an authorized social media platform. The one or more advertisements may be based on social profile data or category data received from the social media analysis component 230. Once the marketing component 236 has generated an advertisement, the publishing component 228 may publish the advertisement as a social media post on an authorized social media platform.

In the illustrated example, the social media interaction module 210 may further include a commerce component 232. The commerce component 232 may support transactions made via the vendor account. For example, the commerce component 232 may support payments initiated by an authenticated user for online purchases. The commerce component 232 may further integrate with the payment functionality of authorized social media platforms, such that products or services purchased on an authorized social media platform website can be processed via the commerce component 232. Further, the commerce component 232 may support non-monetary transactions such as a transfer of data-allowance associated with a telecommunication service vendor. A recipient of a data-allowance transfer may be another authenticated user associated with the telecommunication service vendor, or a non-authenticated user associated with the telecommunication service vendor. In other examples, the commerce component 232 may support providing an authenticated user with a status of a pending order or a trade-in estimate for the product currently owned by the authenticated user.

The social media interaction module 210 may further include a technical support component 234. The technical support component 234 may support functionality that relates to technical support of a product or service associated with the vendor. In a non-limiting example, an authenticated user may publish a social media post requesting support for a problem with a vendor-issued user device. In doing so, the technical support component 234 may perform an analysis of data obtained from the posting to pinpoint a root cause of the problem. The technical support component 234 may also use data from the data-store 216 to identifies additional information from other authenticated users who have experienced similar problems with similar user devices. In doing so, the technical support component 234 may determine whether the problem is isolated to the particular user device, or whether the problem is more common in user devices sharing the same make or model.

Further, the technical support component 234 may initiate a diagnostic check of a product. The diagnostic check may be initiated by the technical support component 234, and the results may be dynamically uploaded from the product to the technical support component 234. In another example, the technical support component 234 may provide instructions via an authorized social media platform that directs the user to perform the diagnostic check and transmit the results to the technical support component 234. The technical support component 234 may request a data file or an image file of product settings once a diagnostic check has been performed. Using a user device as a product example, product settings may include account settings, operating system settings, network signal strength, and data through-put information.

Once the problem has been identified, the technical support component 234 may cause the publishing component 228 to post a solution to the problem, via an authorized social media platform. In some examples, the solution may involve changing a product setting, downloading a software update, or deleting a problematic software application. In other examples, the solution may require intervention by a customer service representative or network engineering team. In such instances, trouble tickets, problem solving instructions, diagnostic data, and other information may be automatically send to a customer service representative and network engineering team.

In the illustrated example, the memory 206 may further include a data-store 216. The data-store 216 may include multiple database entries that each correspond to an authenticated user of the vendor platform. Each database entry may include profile data associated with the authenticated user, including a vendor account type, vendor account subtype, tenure of authenticated user with the vendor, a billing account number (BAN) address, an email address, a device type and a device identifier. Each database entry within the data-store 216 may include a master agnostic identity 220 that is associated with an authenticated user. In various examples, the master agnostic identity 220 may be used to anonymously identify an authenticated user to one or more authorized social media platforms. The master agnostic identity 220 may also be used as a search term within the data-store 216 to locate a database entry associated with the authenticated user. Further, each database entry may include an indication of authorized social media platforms, such that a search of the data-store 216 using the master agnostic identity 220, may identify each authorized social media platform that is associated with the vendor platform. Further, each database entry within the data-store 216 may include a social media platform ID that is unique to an authorized social media platform. The social media platform ID may be bound to the master agnostic identity 220 such that a database search using the master agnostic identity 220 may identify an association with the authorized social media platform.

Moreover, each database entry within the data-store 216 may include a listing of social media posts associated with each authorized social media platform. In one example, the listening component 226 of the social media interaction module 210 may be configured to retrieve and store within a database entry, social media post IDs that correspond to social media posts stored on an authorized social media platform that directly or indirectly reference the vendor. In various examples, a social media post ID may be an identifier that may locate a social media post on an authorized social media platform. In another example, the listening component 226 may be configured to retrieve and store within a database entry, social media post IDs associated with social media posts that may help determine whether to market particular products or services. In this example, the corresponding database entry may include social media posts that were retrieved for marketing purposes.

Further, context information and/or metadata may be included within each database entry of the data-store 216. Context information and/or metadata may describe a theme, topic, or feature of individual social media posts within a database entry. For example, context information may tie a social media post ID to a transaction of products purchased on the social media platform, or a payment of an outstanding bill on the vendor platform. Context information may also associate social media posts with particular categories of data based on category indications received from the social media analysis component 230.

It is noteworthy, that the data-store 216 may provide access to database entries that correspond to authenticated users, and remove access to database entries that correspond to non-authenticated users. In other words, in the event that a user authentication expires or is revoked, references to user data within a database entry of the user may remain inaccessible via the vendor platform. In some examples, references to the user data may remain stored on the data-store 216 for a predetermined period of time, but remain inaccessible via a user interface 214. In other examples, the user data may be removed from the data-store 216. Further, the data-store 216 may limit access to some, but not all, of the user data within a database entry. For example, the data-store 216 may provide access to user data associated with an authorized social media platform, and remove access to user data associated with an unauthorized social media platform. In other words, in the event that an association between an authenticated user and an authorized social media platform is terminated or is revoked, user data that is stored within the database entry of the user, may remain inaccessible via the vendor platform. In some examples, the user data may remain stored on the data-store 216 for a predetermined period of time, but remain inaccessible. In other examples, the user data may be removed from the data-store 216.

Further, user data that is stored within a data-store 216 may be used by the technical support component 234 to determine whether a problem with a particular device is an isolated problem with that particular device, and a problem is more commonly associated with all devices of that specific make or model. In a non-limiting example, data that is obtained from a particular user may indicate that a particular user device has a network signal issue at a particular geolocation. However, if data from other users with the same device make or model indicates that those users have not experienced a similar problem, the technical support component 234 may determine that the problem that the particular device is experiencing is an isolated problem.

If, however, data within the data-store 216 indicates that the problem is common to devices of particular make or model, the technical support component 234 may cause the publishing component 228 to preemptively transmit an indication to all users that carry the device that a problem has been identified, and a solution to the problem is either included or forthcoming.

In the illustrated example, the memory 206 may further include a search/query module 212 may permit the vendor search through the data-store 216. The search/query module 212 may be used to query social activity associated with an authenticated user, or retrieve indicia associated with that social activity, such as an identity of the authorized social media platform. Further, the search/query module 212 may permit the vendor to search through the data-store based on context information and metadata that is associated with individual social media posts. In a non-limiting example, this feature may help in identifying a solution to a technical problem for a particular product or service by searching through social media posts of other authenticated users who have experienced similar problems with similar products or services. In some examples, context information and metadata may include a product model number or product make, or the geolocation of a problem.

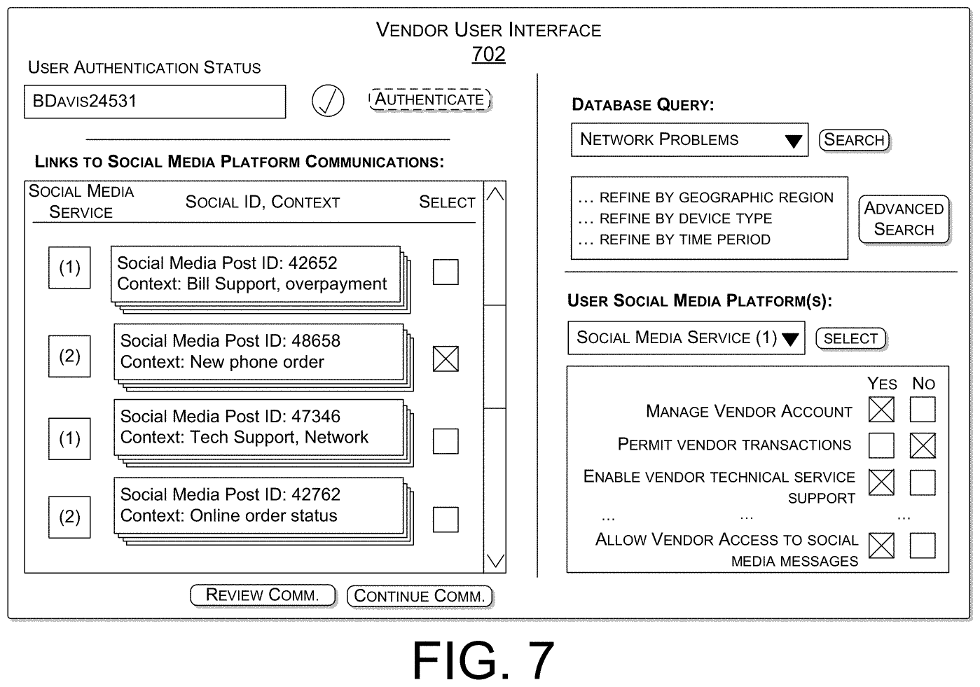

In the illustrated example, the memory 206 may further include a user interface 214 to customize configuration settings for the vendor-social media integration system 202. As described in further detail in FIG. 7, the user-interface may allow a vendor to determine whether a user has been authenticated to the vendor platform. In instances where the user has not been authenticated, the vendor may initiate a request to authenticate the user via a click to action selection. Further, the user interface 214 may include a record of communication threads between the user and the vendor across various authorized social media platforms. A communication thread may include all social media posts communicated between a user and the vendor platform, for the purpose of resolving a particular request. For example, a first communication thread may include social media posts that relate to payment of an outstanding bill. Similarly, a second communication thread may include all social media posts that relate to the resolution of a technical support request. Further, the user interface 214 may provide the vendor with an option to add a new social media post to an existing communication thread. For example, if a user and vendor had initially resolved a request for bill support, the vendor may follow-up with the user, at a later date and on the same communication thread, to ensure that the user's initial request for billing assistance had been resolved. In the event that the issue had not been resolved, the vendor would have access to all social media posts within the communication thread, thus providing context to the issue, without having the user provide an account of the problem and attempted solutions.

The user interface 214 may also include a database query field to facilitate a search through the data-store 216. Further, the user interface 214 may also include a summary of permissions associated with each authorized social media platform. A benefit of the user interface 214 including a summary of permissions is that an operator may readily identify a misuse event associated with a transfer of data between the vendor account and an authorized social media platform.

In the illustrated example, the vendor-social media integration system 202 may further include input/output interface(s) 238. The input/output interface(s) 238 may include any type of output interface known in the art, such as a display (e.g. a liquid crystal display), speakers, a vibrating mechanism, or a tactile feedback mechanism. Input/output interface(s) 238 also include ports for one or more peripheral devices, such as headphones, peripheral speakers, or a peripheral display. Further, the input/output interface(s) 238 may further include a camera, a microphone, a keyboard/keypad, or a touch-sensitive display. A keyboard/keypad may be a push button numerical dialing pad (such as on a typical telecommunication device), a multi-key keyboard (such as a conventional QWERTY keyboard), or one or more other types of keys or buttons, and may also include a joystick-like controller and/or designated navigation buttons, or the like.

In the illustrated example, the vendor-social media integration system 202 may include one or more network interface(s) 240. The one or more network interface(s) 240 may include any sort of transceiver known in the art. For example, the one or more network interface(s) 240 may include a radio transceiver that performs the function of transmitting and receiving radio frequency communications via an antenna. In addition, the one or more network interface(s) 240 may also include a wireless communication transceiver and a near field antenna for communicating over unlicensed wireless Internet Protocol (IP) networks, such as local wireless data networks and personal area networks (e.g. Bluetooth or near field communication (NFC) networks). Further, the one or more network interface(s) 240 may include wired communication components, such as an Ethernet port or a Universal Serial Bus (USB).

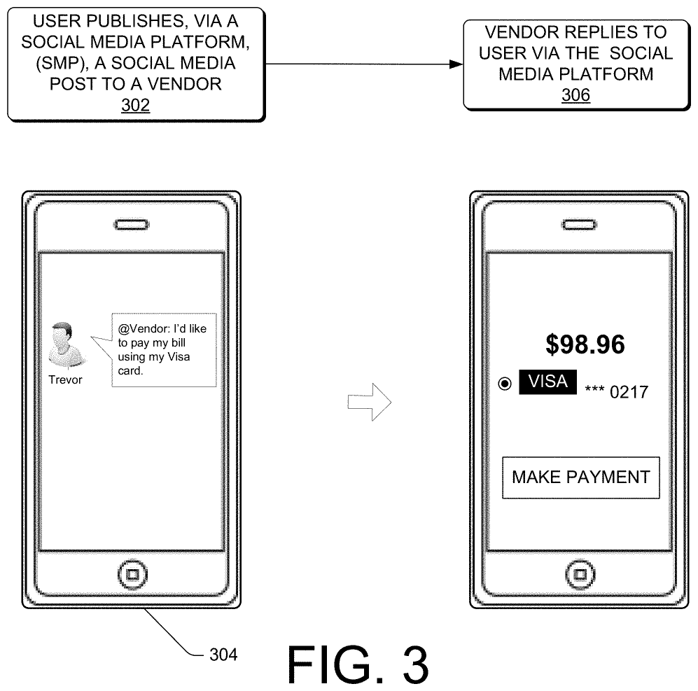

FIG. 3 illustrates a block diagram of a vendor-social media integration system facilitating a payment transfer from a user to a vendor. At block 302, the user may post a social media post that is directed to a vendor via an authorized social media platform. The user may include a handler associated with the vendor, such as “#Vendor.” Alternatively, or additionally, the user may include a handler associated with an action to be performed by the vendor. For example, the user may include a “#billpay” handler in a social media post that is intended to facilitate a payment transfer from a user account to the vendor. In other examples, the user may omit the inclusion of a handler, and instead rely on natural language processing of the vendor-social media integration system to determine an intent of the social media post. The social media post may request a payment transfer of a particular amount using a financial instrument on record with the vendor. In the illustrated example, the user, via user device 304, initiates payment for an outstanding bill. In other examples, the user may initiate payment for the purchase of a particular product or service associated with the vendor.

At block 306, the user may receive a reply post via the social media platform requesting confirmation from the user of the payment amount and the financial instrument to be used for processing the payment. In the illustrated example, a selectable option to “make payment” may be included in the reply post. Thus, the user need not navigate away from the social media platform to initiate the bill payment. Instead, the transaction may be streamlined from beginning to end, on the social media platform. In some examples, rather than initiating payment for an outstanding bill or the purchase of a particular product or service, the same process of the vendor-social media integration system may be used to solicit a vendor for an offer for a trade-in payment for a particular product, or to solicit an order status of a pending order associated with the vendor.

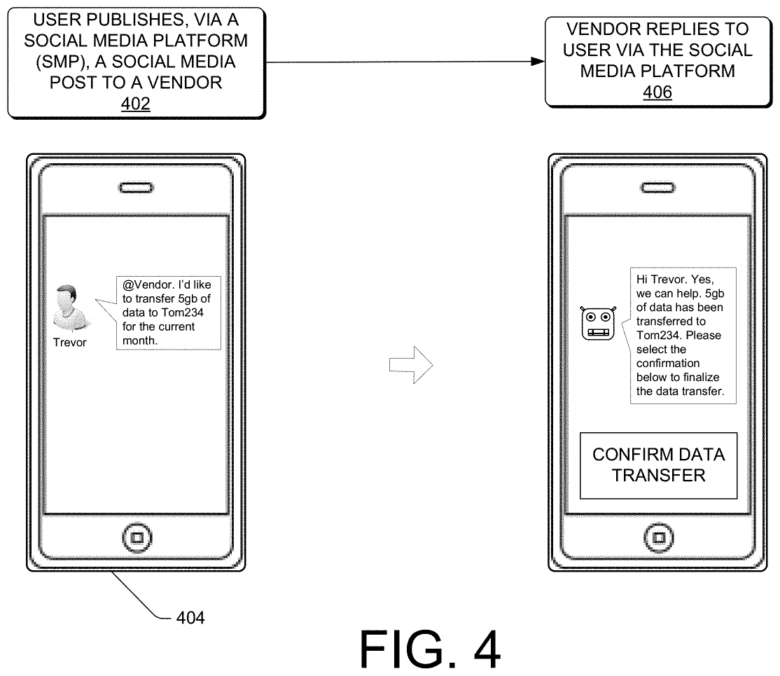

FIG. 4 illustrates a block diagram of a vendor-social media integration system facilitating a data-allowance transfer from a user to a recipient of a telecommunications service vendor. At block 402, the user may post a social media post that is directed to a vendor via an authorized social media platform. The user may include a handler associated with the vendor, such as “#Vendor.” Alternatively, or additionally, the user may include a handler associated with an action to be performed by the vendor. For example, the user may include a “#datastash” handler in a social media post that is intended to facilitate a data-allowance transfer from a user account to a recipient account of a telecommunications service vendor.

At block 406, the user may receive a reply post via the social media platform requesting confirmation from the user for the data-allowance transfer from the user account to the vendor account of a recipient. In the illustrated example, a selectable option to “confirm payment” may be included in the reply post. Thus, the user need not navigate away from the social media platform to initiate the data-allowance transfer. Instead, the transaction may be streamlined from beginning to end, on the social media platform.

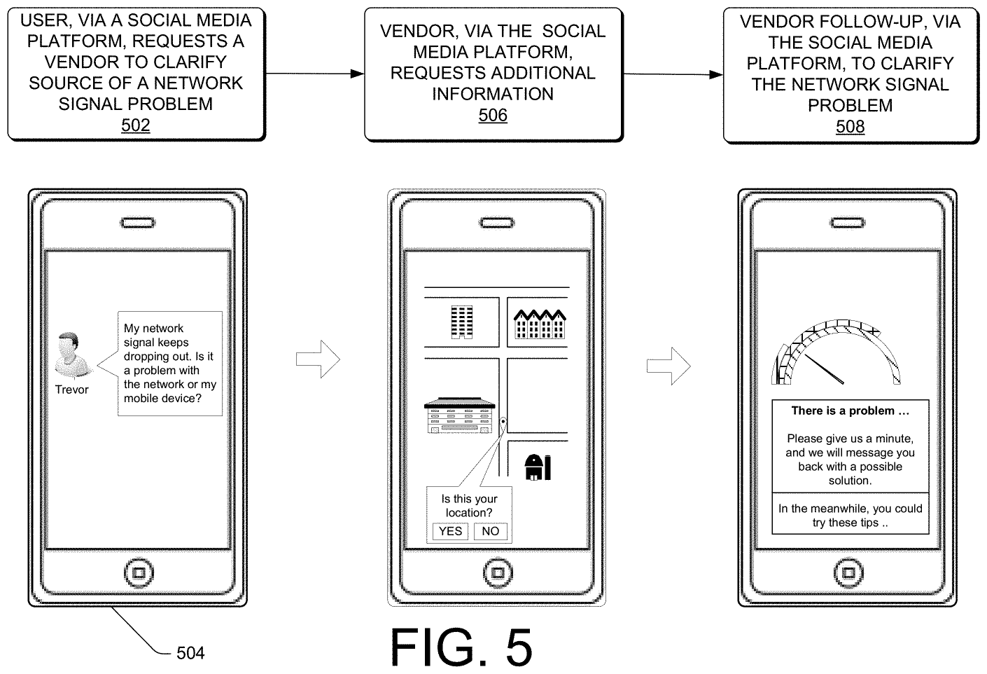

FIG. 5 illustrates a block diagram of a vendor-social media integration system facilitating a technical support request from a use to a telecommunications service vendor. At block 502, the user may post a social media post that is directed to a vendor via an authorized social media platform. The user may include a handler associated with the vendor, such as “#Vendor.” Alternatively, or additionally, the user may include a handler associated with an action to be performed by the vendor. For example, the user may include a “#techsupport” handler in a social media post that is intended to facilitate a payment transfer from a user account to the vendor. In the illustrated example, the user omits the inclusion of a handler, and instead rely on natural language processing of the vendor-social media integration system to determine an intent of the social media post. Further, the social media post states that the user is experiencing network problems, and is asking whether the problem is due to the telecommunications network or user device 504. Thus, natural language processing of the vendor-social media integration system may identify keywords and key phrases, such as “signal . . . dropping out” and “network” and thus direct the social media post to a technical support component of the vendor platform.

At block 506, the user may receive a reply social media post requesting additional information. The request may be outlined in the text of the reply social media post. Alternatively, or additionally, the user may receive a link to an in-browser application that may guide the user through a series of troubleshooting steps. The user may provide additional information by reporting an outcome of the troubleshooting steps. In another example, the user may receive a link to an in-browser application that performs a diagnostic analysis of the user device. In this example, the additional information may be retrieved from the user device without requiring additional user intervention. In the illustrated example, the vendor may request additional information that confirms a geo-location associated with the user device. In some examples, the vendor may be able to determine the geo-location of the signal problem via a global positioning system (GPS) sensor on the user device 504. However, at times, an accuracy of the GPS sensor may be influenced by noise in the GPS radio signal, atmospheric conditions, or natural barriers that interfere with the GPS radio signal. Thus, the vendor may require an alternate means of determining a current geo-location. In these instances, the user may be prompted to submit a picture taken at a current geo-location of the user device. The picture may be used by the vendor to precisely pinpoint the location of the user device. Alternatively, or additionally, the reply social media post may include a link to an in-browser application that may allow the user to pinpoint a current location on an interactive map. The interactive map may be generated based on an approximate location of the user device.

At block 508, the user may receive a vendor follow-up, via the social media platform, to clarify the nature of the signal problems. In the illustrated example, the vendor may include additional information, such as tips, to help improve user experience. Thus, the user need not navigate away from the social media platform to seek technical support from a vendor. Instead, the technical support process may be streamlined from beginning to end, on the social media platform. In some examples, rather than requesting clarification of network problems, the same process of the vendor-social media integration system may be used to initiate and perform diagnostic checks on the user device 504, particularly if it is determined that a problem with signal drop out is not due to the telecommunications network, and is instead due to the user device 504.

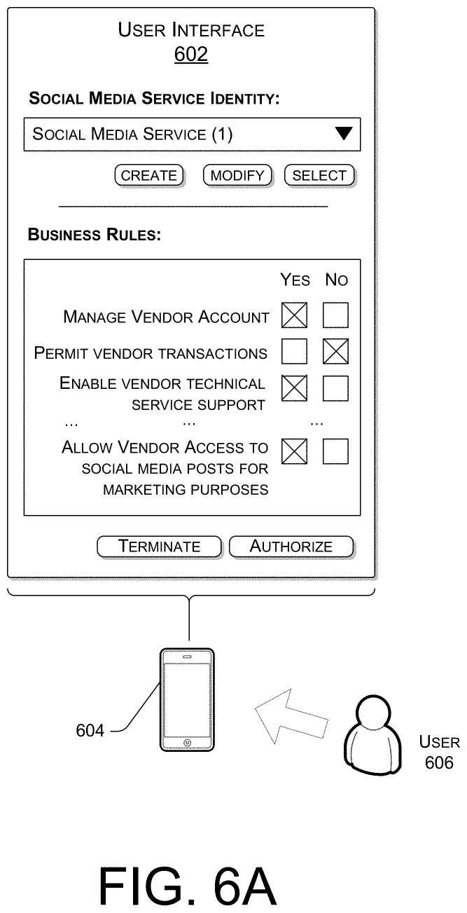

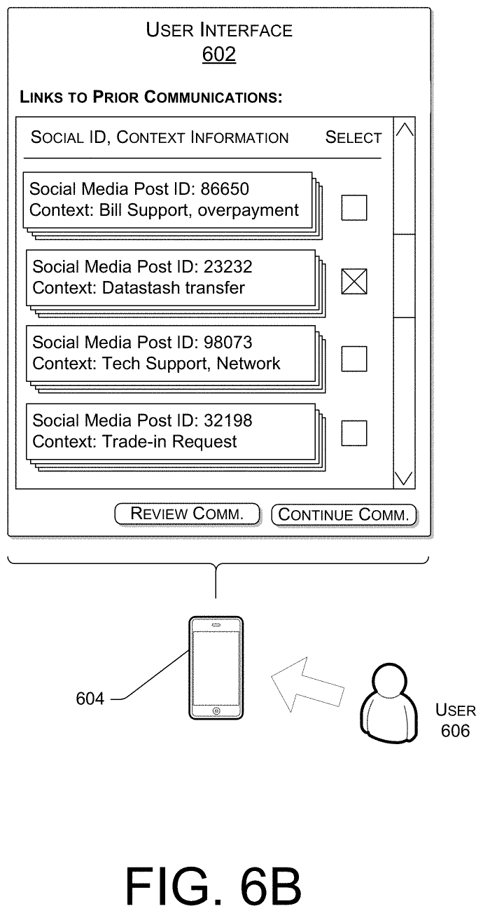

FIG. 6A illustrates an exemplary user interface 602 of a user device 604 that may customize an authorization of a social media network service. In this example, the user interface 602 may allow the user 606 to establish or modify an association between the vendor platform and a social media platform. Further, the user interface 602 may allow the user 606 to configure one or more business rules that the user 606 intends to govern the interaction between the social media platform and the vendor account. For example, one or more business rules may include selectable options that permit a use of the social media platform for managing the vendor account, facilitating vendor transactions, facilitating vendor technical service support, and allowing vendor access to social media posts for marketing purposes.

FIG. 6B illustrates an exemplary user interface of a user device 604 that displays a listing of prior communications with a vendor platform. Prior communications may be represented as multiple communication threads of discrete communications initiated between the user 606 and the vendor. Each communication thread may include a social media post ID that may identify the actual social media post published by the user on an authorized social media platform. Further, each communication thread may also include context information that describes a topic, theme, or feature that relates to the social media post. For example, if a user chooses to engage the vendor about an accidental bill overpayment, the context information of the social media post may be recorded as “bill support, overpayment.” In various examples, the user interface 602 may provide the user 606 with an option to include a new social media post to a selected communication thread. For example, if a user 606 had initially requested assistance with a bill, and the vendor was ultimately unable to resolve the issue, the user 606 may include the new social media post to the same communication thread that relates the initial request for billing assistance. Providing access to communication threads and including all social media posts within each communication thread allows support staff of the vendor to understand a history of the request for assistance, without having the user 606 retell the problem and recap previous attempts at a solution.

FIG. 7 illustrates an exemplary user interface of a vendor platform that may facilitate interactions with an authenticated user. In the illustrated example, the user interface 702 may display an authentication status of a user. In the event that user authentication has lapsed, a selectable option to “authenticate” may push a notification to a user device associated with the user that prompts authentication. Once a user has been authenticated, the user interface 702 may display prior communications, as well facilitate database queries. In the illustrated example, the user interface 702 may include prior communications between an authenticated user and the vendor platform. Prior communications may be represented as multiple communication threads of discrete communications initiated between the user and the vendor across various authorized social media platforms. Each communication thread may include a social media post ID that may identify the actual social media post published by the user on an authorized social media platform. Further, each communication thread may also include context information that describes a topic, theme, or feature that relates to the social media post. In various examples, the user interface 702 may provide the vendor with an option to include a new social media post to a selected communication thread. For example, if a user had initially requested assistance with a bill, the vendor may follow-up with the user at a later date and on the same communication thread that relates the request for billing assistance.

The user interface 702 may also include a database query field to facilitate a search through the data-store. In the illustrated example, the database query field may allow for topical searches, as well as refined searches. In the illustrated example, the user interface 702 may also include a summary of permissions associated with each authorized social media platform. A benefit of the user interface 702 including a summary of permissions is that an operator may readily identify a misuse event associated with a transfer of data between the vendor account and an authorized social media platform.

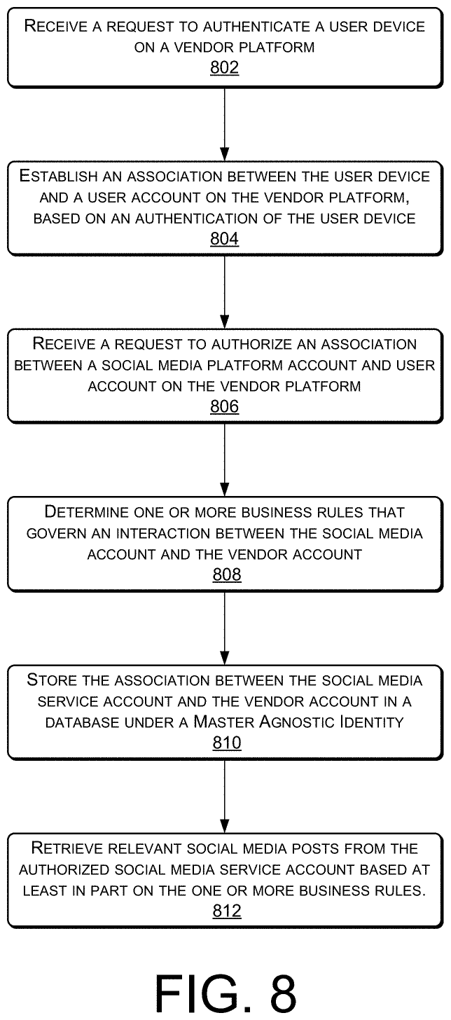

FIG. 8 illustrates a flow diagram that describes a process of authorizing an association between a social media platform account and a vendor account, and retrieving data from the social media platform account based at least in part on the authorized association. In various examples, a user may request a vendor-social media integration system to authorize access to a social media platform via a vendor account. In doing so, the user may interact with vendor account via a preferred messaging service of the authorized social media platform. In this example, the vendor-social media integration system may monitor and reply to social media posts on the authorized social media platform.

At 802, the vendor-social media integration system may receive a request to authenticate a user identity on a vendor platform. In some examples, a user identity may be authenticated via entry of a user name and password, a biometric identifier, or a device identifier. The device identifier may correspond to an MSISDN number of the user device that automatically authenticates the user device when the user device is operating on a vendor-supported telecommunication network. Further, a record of an association between the device identifier and the vendor platform may be stored on the data-store of the vendor-social media integration system, under the appropriate database entry that corresponds to the user.

At 804, once a user identity has been authenticated on the vendor platform, the vendor-social media integration system may associate a user device that is associated with the authenticated user identity, with a user account on the vendor platform. In some examples, the association may be valid for an indeterminate period of time while the user device operates on a telecommunications service network shared with the vendor platform. In other examples, the association may be valid for a predetermined period of time that commences when the user device authenticates to the vendor platform. In this example, once the predetermined period of time expires, the user device may be required to initiate a new authentication with the vendor platform.

At 806, in response to authenticating a user device on the vendor platform, and further associating the user device with a vendor account, the vendor-social media integration system may receive, from the user device, a request to authorize an association between a social media platform account and a vendor account. In various examples, the request may be generated by selectable click-through options displayed on a user interface. The request may include an identity of the social media platform, user authentication details associated with the social media platform, and one or more criteria that the user intends to govern the interaction between the social media platform and the vendor account. For example, the one or more business rules may include selectable options that permit a use of the social media platform for managing the vendor account, facilitating vendor transactions, facilitating vendor technical service support, and allowing vendor access to social media posts for marketing purposes.

At 808, the vendor-social media integration system may determine one or more business rules that govern the interaction between the social media platform account and the vendor account. The one or more business rules may be based at least in part on the one or more business rules that the user selected as part of the request to authorize the association at 802. For example, the one or more business rules may permit a use of the social media platform for managing the vendor account, facilitating vendor transactions, facilitating vendor technical service support, and allowing vendor access to social media posts for marketing purposes. Further, the one or more business rules may also include a predetermined time period for which the association between the social media platform account and the vendor account remains authorized. In other words, at an expiration of the predetermined time period, the association between the social media platform and the vendor account is terminated.

At 810, the vendor-social media integration system may store the association between the social media platform account and the vendor account in a database. The association along with the corresponding one or more business rules may be stored under a master agnostic identity, so as to protect a user's identity while conducting one or more transactions through the vendor account.

At 812, the vendor-social media integration system may retrieve relevant social media posts from the authorized social media platform account based at least in part on the one or more business rules. Relevant social media posts may be based at least in part on a direct or indirect reference to the vendor in the social media post.

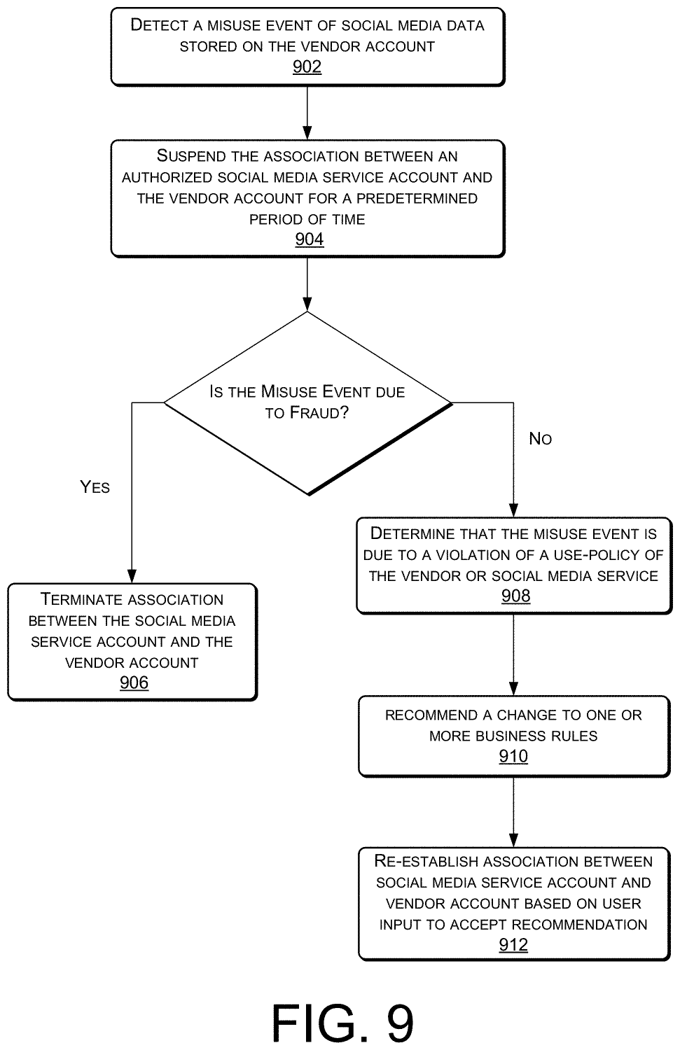

FIG. 9 illustrates a flow diagram that describes a process of identifying a misuse event of social media posts that may cause a termination of the association between a social media platform account and a vendor account. In various examples, misuse event may be detected by the vendor-social media integration system, or may be reported to the vendor by a social media platform. Alternatively, or additionally, a misuse event may be reported by the user.

At 902, the vendor-social media integration system may detect a misuse event of social media data stored on the vendor account. In various examples, the misuse event may correspond to a violation of a use-policy set by the vendor, a use-policy set by the authorized social media platform, or the one or more business rules that govern the interaction between the authorized social media platform account and the vendor account. In other examples, a misuse event may be defined by a detection of fraudulent use of account details associated with the vendor account of the social media platform account.

At 904, the vendor-social media integration system may suspend the association between an authorized social media platform account and the vendor account for a predetermined period of time. In various examples, the predetermined period of time may be based at least in part on a time period that is required to determine a cause of the misuse event. Thus, the predetermined period of time may vary on a case-by-case basis.

At 906, the vendor-social media integration system may determine that the misuse event was due to a fraudulent use of account details associated with the vendor account or the social media platform account. In doing so, the association between the social media platform account and the vendor account may be terminated to prevent further fraudulent use of user account details.

At 908, the vendor-social media integration system may determine that the misuse event is not due to fraud. In doing so, the vendor-social media integration system may determine that the cause of the misuse event is a violation a use-policy set by the vendor or the social media platform. In some examples, the use-policy set by the vendor may include the one or more business rules generated to govern the interaction between the social media platform account and the vendor account.

At 910, the vendor-social media integration system may recommend a change to one or more business rules to alleviate the violation of the use-policy set by the vendor or the social media platform account. Consider an example where a misuse event is defined by an attempt to gain access to social media data for the purpose of marketing vendor products or services. Further, consider a use-policy set by the social media platform that indicates that social media data should not be shared with a third party for the purpose of marketing third party products or services. In this example, the vendor-social media integration system may alleviate a violation to the use-policy set by the social media platform by recommending a change to one or more business rules that prevent access to social media data for the purpose of marketing vendor products or services to the user.

At 912, the vendor-social media integration system may re-establish the association between the social media platform account and the vendor account based at least in part on receipt of a user input accepting the recommendation to change the one or more business rules.

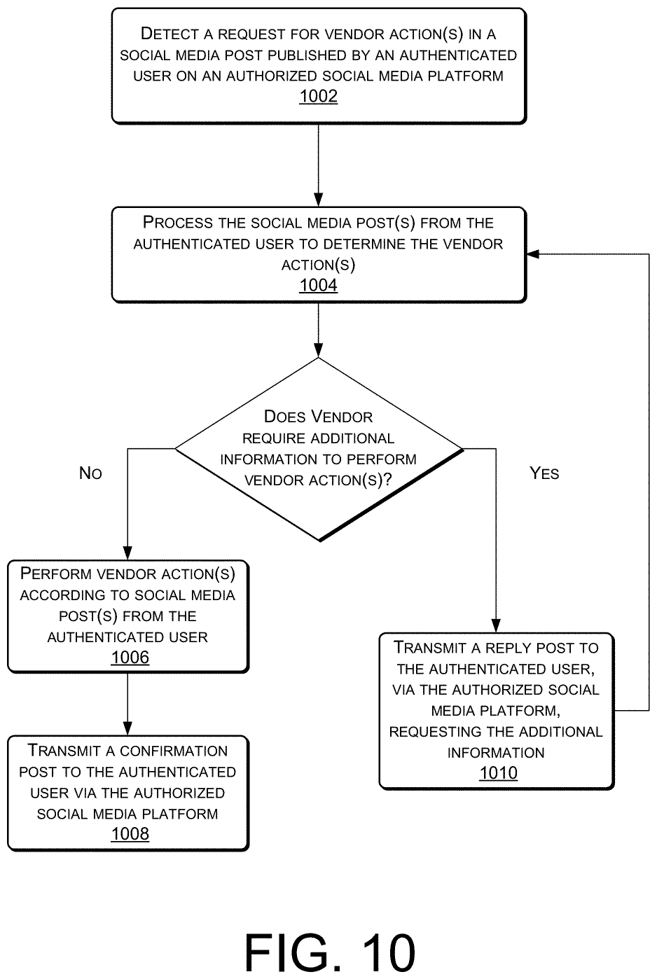

FIG. 10 illustrates a flow diagram of a process of initiating one or more vendor actions in response to receiving a user request via an authorized social media platform. The user request for one or more vendor actions may correspond to various types of interactions with a vendor account. In one example, the user request may correspond to an offer of payment for an outstanding invoice, or an offer of payment for the purchase of a particular product or service. In a second example, the user request may solicit a vendor to offer a trade-in payment for a particular product held by the user. In a third example, the user request may solicit technical support for a product or service associated with the vendor.

At 1002, the vendor-social media integration system may detect a request for one or more vendor actions in a social media post published by an authenticated user via an authorized social media platform. Particularly, the vendor-social media integration system may detect the request based on a direct or indirect reference to a vendor or vendor product or service in the social media post. For example, the social media post may directly reference the vendor or the vendor product or service in statements such as “I would like to pay my vendor bill” or, “I would like to transfer 5 gb of data allowance from my vendor account to Daniel @43.” In another example, the social media post may indirectly reference the vendor or vendor product or service in statements such as “the network signal on my user device keep dropping out. Can you please help me troubleshoot the problem?” In this latter example, the statement of a ‘network signal dropping out’ may indirectly reference a telecommunication service vendor.

At 1004, the vendor-social media integration system may process the social media post from the authenticated user to identify the one or more vendor actions. Particularly, the vendor-social media integration system may employ natural language processing and refer to lists of text patterns to identify the one or more vendor actions.

At 1006, the vendor-social media integration system may determine that the vendor does not require additional information to perform the one or more vendor actions. For example, the social media post may be directed towards a telecommunication service vendor and request a trade-in value of a current user device. If the user has been authenticated on the vendor-supported telecommunications network using the current user device, the vendor platform may identify the user device type and generate an automated trade-in response without requiring additional information. In another example, an authenticated user may post a request for the status of a pending order. In this example, the vendor platform may identify the pending order and generate an automated response outlining the order status.

Thus, in response to determining that the vendor does not require additional information to perform the one or more vendor actions, the vendor-social media integration system may cause the vendor platform to perform the one or more vendor actions according to the request outlined within the social media post from the authenticated user.

At 1008, the vendor-social media integration system may transmit a confirmation post to the authenticated user via the authorized social media platform. In various examples, the confirmation post may appear as a reply post in the same thread as the original social media post that initiated the request for vendor action.

At 1010, the vendor-social media integration system may determine that additional information may be required to perform the one or more vendor actions. For example, the social media post may be directed towards a telecommunication service vendor and request assistance with network signal problems. In this example, the telecommunication service vendor may request confirmation of a geo-location of the user device to troubleshoot possible causes for network signal problems. In another example, the social media post may request a payment transfer of a particular amount using a financial instrument on record with the vendor. In this example, the vendor platform may require additional confirmation of the amount, recipient, and the financial instrument, prior to initiating the payment transfer.

Thus, in response to determining that additional information may be required to perform the one or more vendor actions, the vendor-social media integration system may transmit a reply post to the authenticated user, requesting the additional information. In various examples, the reply post may appear in the same thread as the original social media post that initiated the request for vendor action.

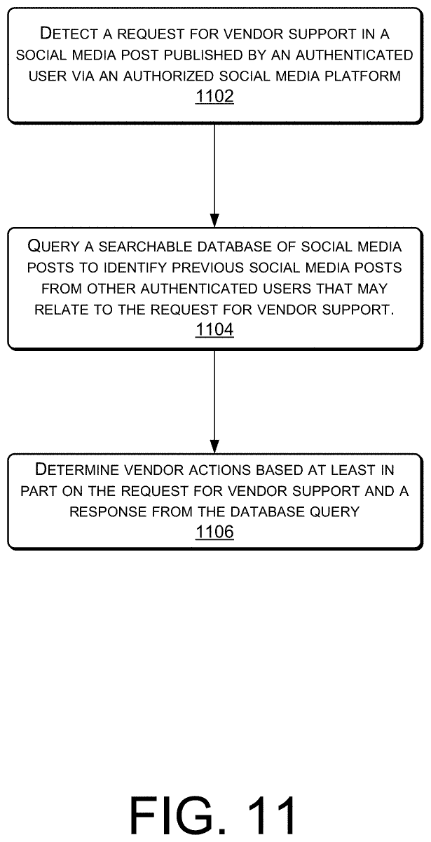

FIG. 11 illustrates a flow diagram of a process for determining a type of vendor actions to perform based on a database query of similar requests for vendor support from other authenticated users. In various examples, the vendor-social media integration system may include a searchable database that includes a listing of social media posts associated directly or indirectly with a vendor. The database may further include context information and/or metadata that describes a theme, topic, or features of individual social media posts. For example, context information may tie a particular social media post to a transaction for a product or a payment made to a vendor account. Context information may also associate a geo-location with a social media post that includes a request for technical support due to poor telecommunications network signals.

At 1102, the vendor-social media integration system may detect a request for vendor support in a social media post published via an authenticated user via an authorized social media platform. In various examples, the request for vendor support may relate to troubleshooting a technical problem associated with a vendor product or service. For example, the request for vendor support may relate to a poor network signal on a user device that is associated with a telecommunication service vendor.

At 1104, the vendor-social media integration system may query a searchable database to identify context information that is associated with previously monitored social media posts, from other authenticated user, that may be relevant to the request for vendor support. For example, context information may reveal that a poor network signal problem may include the user device type that experiences the poor network signal and the geo-location at which the poor network signal occurs.

At 1106, the vendor-social media integration system may determine vendor actions based at least in part on the request for vendor support and a response from the database query. Further, the vendor-social media integration system may perform the vendor actions based on methodology described in FIG. 10.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

1-16. (canceled)

17. A computer-implemented method, comprising:
under control of one or more processors:
transmitting, via a user interface of a user device, a request to authenticate access of the user device to a first user account on a vendor platform, the request including a device identifier that associates the user device with the first user account;
receiving, from the vendor platform, a first indication of authenticated access to the first user account on the vendor platform;
selecting, via the user interface, one or more business rules to authorize an association between the first user account and a second user account on a social media platform;
receiving, from the vendor platform, a second indication of an authorized association between the first user account and the second user account, based at least in part on the one or more business rules;
publishing, via the user interface, a social media post on the second user account, the social media post including a request for one or more actions to be performed by the vendor platform, the one or more actions being associated with the first user account; and
receiving, from the vendor platform, a third indication that corresponds to a performance of the one or more actions.

18. The computer-implemented method of claim 17, wherein the one or more actions corresponds to performing a transaction for a product or service associated with the first user account, and wherein the third indication indicates an occurrence of a fraudulent misuse event associated with the transaction for the product or service; and further comprising:
receiving, from the vendor platform, a fourth indication that the association between the first user account and the second user account has been terminated.

19. The computer-implemented method of claim 17, wherein the third indication indicates that the one or more actions violates a use-policy associated with the vendor platform or a use-policy associated with the social media platform; and
receiving, from the vendor platform, a fourth indication that the association between the first user account and the second user account has been suspended, based at least in part on the third indication.

20. The computer-implemented method of claim 19, further comprising:
modifying, via the user interface, at least one business rule of the one or more business rules to create at least one modified business rule, based at least in part on the fourth indication, the at least one modified business rule complying with a violation of the use-policy associated with the vendor platform or the use-policy associated with the social media platform; and
receiving, an additional indication that the association between the first user account and the second user account has been reestablished, based at least in part on the at least one modified business rule.

21. A vendor-social media integration system comprising:
one or more processors;
memory coupled to the one or more processors, the memory including non-transitory computer-readable media storing executable instructions that, when executed by the one or more processors, cause the one or more processors to perform operations comprising:
associating, in respective database entries of a searchable data-store, vendor account identifiers of vendor accounts of respective users on a vendor platform with respective user identifiers of the users on a plurality of social media platforms;
storing a master agnostic identity of each user of the respective users in the respective database entries in the searchable data-store, in association with the user account identifiers and with the social media platform in each of the respective database entries;
obtaining the social media platform IDs with the master agnostic identity of each user as a key;
accessing, with the respective social media platform IDs as keys, the social media activity by the users on all of the social media platforms associated with the master agnostic identity for each of the users;
monitoring the accessed social media activity by the users on all of the social media platforms associated with the master agnostic identity of each of the respective users;
detecting, among the monitored social media activity, posts by each of the users in that user's social media activity on the social media platforms;
aggregating a plurality of social media posts from different users on their respective social media platforms;
auditing the aggregated social media posts for workflow requests;
analyzing the workflow requests; and
determining, based on the analyzed workflow requests, a social media platform from which to aggregate social media posts related to account transactions.

22. The vendor-social media integration system of claim 21, wherein the executable instructions, when executed by the one or more processors, cause the one or more processors to perform operations further comprising:
authenticating access of a user device of one of the users to its vendor account, using a device identifier that is associated with the user device and the vendor account;
determining that the authentication of the user device to access the vendor account has expired;
notifying the user device that the authentication of the user device to the vendor account has expired; and
initiating another authentication of the user device to the vendor account using the device identifier.

23. The vendor-social media integration system of claim 22, wherein the executable instructions, when executed by the one or more processors, cause the one or more processors to perform operations further comprising:
notifying the user device that the authentication for access has expired; and
presenting a selectable option to initiate a new authentication.

24. The vendor-social media integration system of claim 22, wherein the associating of the vendor account identifiers and the plurality of social media platforms enables two-way communication between the vendor-social media integration system and the user via one of the social media platforms.

25. The vendor-social media system of claim 21, wherein the account transactions include a transaction for a product or service associated with one or more of the user account identifiers.

26. The vendor-social media system of claim 21, wherein the executable instructions, when executed by the one or more processors, cause the one or more processors to perform operations further comprising:
generating a respective profile of each of the users based on social media posts in the user's social media activity on the social media platforms;
interpreting the social media posts on which the profile of each of the users is generated, respectively; and
including, based on the interpreted social media posts, the user in predetermined categories that relate to the social media posts on which the profile of the user is generated.

27. The vendor-social media integration system of claim 26, wherein the categories include one or more of musical genre and type of food.

28. The vendor-social media system of claim 21, wherein the executable instructions, when executed by the one or more processors, cause the one or more processors to perform operations further comprising:
receiving a selection of one or more business rules to authorize an association between the a first user account of a first user and a second user account of a second user on a social media platform;
receiving, from the vendor platform, an indication of an authorized association between the first user account and the second user account, based at least in part on the one or more business rules;
detecting a social media post on a social media platform associated with the second user account, the social media post including a request for one or more actions to be performed by the vendor platform, the one or more actions being associated with the first user account; and
receiving, from the vendor platform, an indication that corresponds to a performance of the one or more actions.

29. One or more non-transitory computer-readable media storing executable instructions that, when executed by one or more processors, cause the one or more processors to perform operations comprising:
associating, in respective database entries of a searchable data-store, vendor account identifiers of vendor accounts of respective users on a vendor platform with respective user identifiers of the users on a plurality of social media platforms;
storing a master agnostic identity of each user of the respective users in the respective database entries in the searchable data-store, in association with the user account identifiers and with the social media platform in each of the respective database entries;
obtaining the social media platform IDs with the master agnostic identity of each user as a key;
accessing, with the respective social media platform IDs as keys, the social media activity by the users on all of the social media platforms associated with the master agnostic identity for each of the users;
monitoring the accessed social media activity by the users on all of the social media platforms associated with the master agnostic identity of each of the respective users;
detecting, among the monitored social media activity, posts by each of the users in that user's social media activity on the social media platforms;
aggregating a plurality of social media posts from different users on their respective social media platforms;
auditing the aggregated social media posts for workflow requests;
analyzing the workflow requests; and
determining, based on the analyzed workflow requests, a social media platform from which to aggregate social media posts related to account transactions.

30. The one or more non-transitory computer-readable media of claim 29, wherein the executable instructions, when executed by the one or more processors, cause the one or more processors to perform operations further comprising:
authenticating access of a user device of one of the users to its vendor account, using a device identifier that is associated with the user device and the vendor account;
determining that the authentication of the user device to access the vendor account has expired;
notifying the user device that the authentication of the user device to the vendor account has expired; and
initiating another authentication of the user device to the vendor account using the device identifier.

31. The one or more non-transitory computer-readable media of claim 30, wherein the executable instructions, when executed by the one or more processors, cause the one or more processors to perform operations further comprising:
notifying the user device that the authentication for access has expired; and
presenting a selectable option to initiate a new authentication.

32. The one or more non-transitory computer-readable media of claim 30, wherein the associating of the vendor account identifiers and the plurality of social media platforms enables two-way communication between the vendor-social media integration system and the user via one of the social media platforms.

33. The one or more non-transitory computer-readable media of claim 29, wherein the account transactions include a transaction for a product or service associated with one or more of the user account identifiers.

34. The one or more non-transitory computer-readable media of claim 29, wherein the executable instructions, when executed by the one or more processors, cause the one or more processors to perform operations further comprising:
generating a respective profile of each of the users based on social media posts in the user's social media activity on the social media platforms;
interpreting the social media posts on which the profile of each of the users is generated, respectively; and
including, based on the interpreted social media posts, the user in predetermined categories that relate to the social media posts on which the profile of the user is generated.

35. The one or more non-transitory computer-readable media of claim 34, wherein the categories include one or more of musical genre and type of food.

36. The one or more non-transitory computer-readable media of claim 29, wherein the executable instructions, when executed by the one or more processors, cause the one or more processors to perform operations further comprising:
receiving a selection of one or more business rules to authorize an association between the a first user account of a first user and a second user account of a second user on a social media platform;
receiving, from the vendor platform, an indication of an authorized association between the first user account and the second user account, based at least in part on the one or more business rules;
detecting a social media post on a social media platform associated with the second user account, the social media post including a request for one or more actions to be performed by the vendor platform, the one or more actions being associated with the first user account; and
receiving, from the vendor platform, an indication that corresponds to a performance of the one or more actions.
